(19) United States
(12) Patent Application Publication
(10) Pub. No.: US 2005/0221773 A1
(43) Pub. Date: Oct. 6, 2005

(54) Tuning system

(75) Inventors: Dominicus Martinus Wilhelmus Leenaerts, Eindhoven (NL); Cicero Silveira Vaucher, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/518,268

(22) PCT Filed: Jun. 12, 2002
(86) PCT No.: PCT/IB03/02732

§ 371 Date: Dec. 16, 2004

(30) Foreign Application Priority Data
Jun. 24, 2002 (EP) 02077504.5

(51) Int. Cl. H04B 1/04

(52) U.S. Cl. 455/125; 455/120

(57) ABSTRACT

A tuning system (100) for receiving a radio frequency input signal included in a frequency range, the range having a maximum frequency and a minimum frequency and a plurality of non-overlapping bands, the tuning system (100) comprising a voltage-controlled oscillator (6) controlled by an analog signal (V_{T}) and a first binary signal (D) and being characterized in that the analog signal (V_{T}) is inputted to a window comparator (1), said comparator (1) having a low threshold (V_{L}) which is indicative for the minimum frequency and a high threshold (V_{H}) which is indicative for the maximum frequency.

The invention relates to a tuning system for receiving a radio frequency input signal included in a frequency range having a maximum frequency and a minimum frequency and a plurality of non-overlapping bands, the tuning system comprising a voltage-controlled oscillator controlled by an analog signal and a first binary signal.

Tuning systems are essential building blocs in communication systems e.g. receivers. A receiver receives a signal included in a frequency range, said range having a plurality of non-overlapping bands. The receiver comprises an oscillator that generates a periodical signal having a frequency that is proportional to the input signal. In modern receivers the oscillators are included in a Phase-Locked Loop (PLL) and are controlled by an analog voltage for continuous tuning. When the frequency range is relatively large the analog signal is not sufficient for modifying the frequency of the periodical signal generated by the oscillator and a supplementary digital control of the oscillator is provided.

U.S. Pat. No. 6,211,745 discloses a PLL comprising a voltage controlled oscillator (VCO), the voltage controlled oscillator comprising a digitally controlled capacitive network coupled to a LC tank circuit. The PLL is used in a Bluetooth system wherein the tuning range is relatively small i.e. 78 MHz from 2.402 GHz to 2.48 GHz. In the same patent it is suggested that the invention could be used also in wide band communication simply by modification of a reference frequency of the PLL, a division factor of a divide-by-M circuit and a value of a digital word used for controlling the capacitive network. However, the frequency of the VCO could not be precisely set for receiving only the signals included within a band. Hence, the receiver also receives signals included in adjacent bands.

It is therefore an object of the present invention obtain a receiver for receiving signals situated only within a frequency band. It is also desirable to have a method for calibrating a receiving system for receiving signals within a frequency range, said range including a plurality of non-overlapping bands.

In accordance with the invention this is achieved in a tuning system as described in the introductory paragraph, the system being characterized in that the analog signal is inputted to a window comparator, said comparator having a low threshold which is indicative for the minimum frequency and a high threshold which is indicative for the maximum frequency. The voltage-controlled oscillator (VCO) generates a periodical output signal, a frequency of this signal being determined by a magnitude of the analog signal. The magnitude of the analog signal is situated within a range having a low threshold and a high threshold. When the analog signal equals the high threshold value, the VCO generates an output signal having the highest frequency. When the analog signal equals the low threshold value, the VCO generates an output signal having the lowest frequency. Hence, the threshold levels could be used as an overflow and an underflow indicator for the frequency of the signal generated by the VCO.

In an embodiment of the invention the window comparator generates a signal that is inputted to a controller, for generating the first binary signal to digitally control an output frequency of the voltage-controlled oscillator. The controller generates a binary signal that is used for controlling switches used for connecting or disconnecting tunable elements to or from tuning devices included in the VCO as e.g. LC tank circuits. In case of LC tank circuits, in most cases the switches connect or disconnect the capacitors included in the tank.

In an embodiment of the invention the controller further generates a second binary signal that is inputted to a frequency divider for determining a division factor of a periodical signal generated by the voltage-controlled oscillator. In any digital system the speed of operation is a critical factor and therefore a reduction of the operation frequency is applied whenever this is possible. Usually the reduction of frequency is achieved in a frequency divider. A digital number determines a frequency divider number representing how many times an input frequency is reduced. This number could be fixed or settable. When a fixed number is used, a ratio between an output frequency and an input frequency characterizing the divider has a predetermined value. When a settable number is used, a ratio between an output frequency and an input frequency characterizing the divider has a value determined by an actual value of the digital number.

In another embodiment of the invention the controller further comprises a local memory for storing binary representations of the frequency range and of each of the bands included in the frequency range. The local memory could be a binary memory for memorizing binary signals that control the output frequency of the VCO. A profile of any output frequency of the VCO is therefore stored in the memory cells of the controller. As an alternative, the memory cells could store the voltages that determine the output frequency of the VCO in e.g. capacitor type memory cells i.e. capacitors are used for storing voltages in a known per se way.

In another embodiment of the invention the tuning system further comprises a PLL, the PLL including a phase detector coupled to the frequency divider. The phase detector generates an error signal that is proportional to a phase difference between a reference periodical signal and a signal generated by the frequency divider. The error signal is inputted to a compound bloc comprising a charge pump coupled to a loop filter, the compound bloc generating the analog signal. The analog signal is used for controlling tunable devices included in the VCO such that the phase difference between the reference signal and the signal generated by the frequency divider is substantially zero.

In another embodiment of the invention the window comparator comprises a first differential comparator and a second differential comparator. The first differential comparator generates a first signal having a first binary value whenever the analog signal is bigger than the high threshold. The second differential comparator generates a second signal having a second binary value whenever the analog signal is smaller that the low threshold. The first binary value and the second binary value could be either HIGH or LOW when indicating the analog signal is either bigger than the high threshold or smaller than the low threshold.

In another embodiment of the invention the voltage-controlled oscillator comprises a plurality of capacitors coupled respectively to a plurality of switches, a state of the switches being controlled by the first digital signal. The switches could be connected to a terminal of any capacitor or, alternatively, they could be disconnected from the capacitors. When a switch is connected to a capacitor, corresponding to a state ON of the switch, the capacitor capacity is added to a overall capacity of the circuit. Considering that the first binary signal has the form D=d1d2 . . . dn wherein di is 0 or 1 and the any switch S1, S2, . . . , Sn is turned ON when the respective di is 1, then the overall capacity could be written as

$$C = {\sum }_{i = 1}^{n} diCi .$$

The preceding relation emphasizes the direct relation between the overall capacity and the first binary signal.

In an embodiment of the invention is presented a tuning method for the tuning system comprising steps of:

1. Setting all the switches in an OFF state i.e. D=00 . . . 0;

2. Modifying the second binary signal sequentially until the first signal (S1) is HIGH;

3. Setting all the switches in an ON state i.e. D=11 . . . 1;

4. Modifying the second binary signal sequentially until the second signal is HIGH;

5. Setting the first binary signal D=00 . . . 1;

6. Adjusting the second binary signal till the first signal becomes HIGH;

7. Adjusting the second binary signal till the second signal becomes HIGH;

8. Storing the second binary signal codes in the controller 3 memory;

9. Modifying the first binary signal to the next value i.e. D=0 . . . 10; and

10. Repeating steps 6 to 9 until all possible D values are used.

Let us make the following notations: Nmax is the division factor obtained in step 2, Nmin is the division factor obtained in step 4, NH is the division factor obtained in step 6, NL is the division factor obtained in step 7.

It is observed that the frequency of the signal generated by the frequency divider has the frequency of the signal generated by the voltage-controlled oscillator divided by the decimal equivalent number of the second binary signal DIV e.g. D_{N}. Let us note the frequency of the signal generated by the voltage-controlled oscillator as fS. It results that after division the frequency of the signal is fS/D_{N}. It is further observed that a useful number is Nrange=NH−NL that indicates how many division numbers are used for tuning within a given frequency band i.e. how many division numbers are necessary for the window comparator to be maintained in a state S1S2=01. Therefore, using the stored numbers for every frequency band the locking process is quickened.

The above and other features and advantages of the invention will be apparent from the following description of exemplary embodiments of the invention with reference to the accompanying drawings, in which:

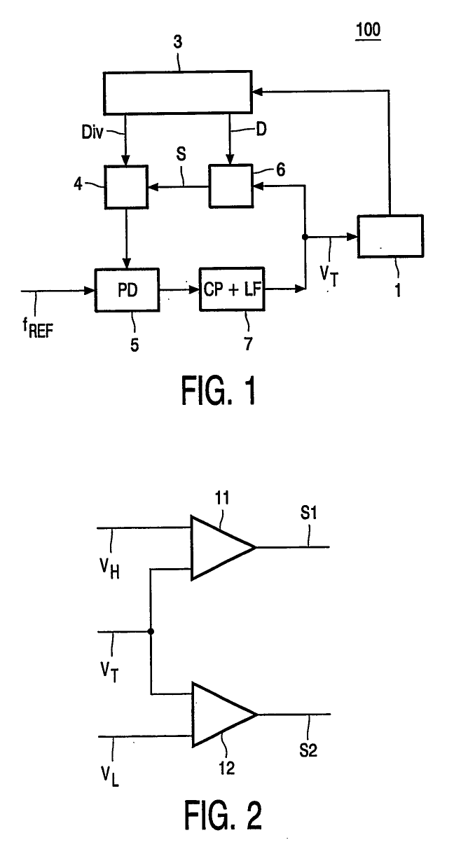

FIG. 1 depicts a tuning system according to the invention,

FIG. 2 depicts a window comparator according to an embodiment of the invention,

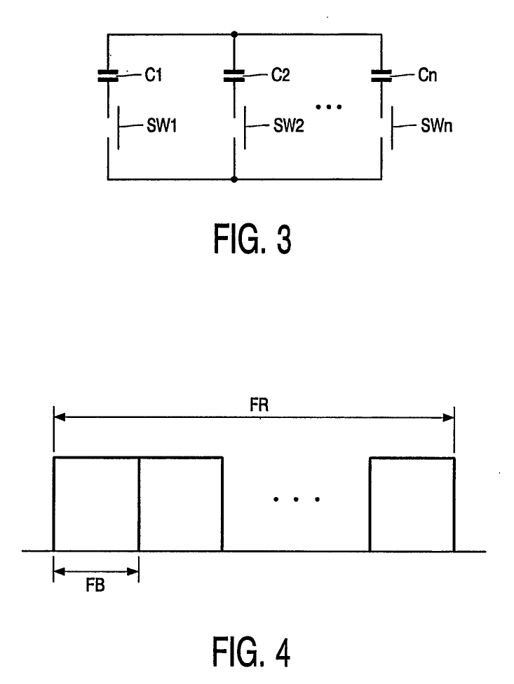

FIG. 3 depicts a bank of capacitors used in a tuning system according to an embodiment of the invention.

FIG. 1 depicts a tuning system 100 according to the invention. The tuning system 100 is designed to receive a radio frequency input signal included in a frequency range having a plurality of non-overlapping bands, a high frequency and a low frequency. The tuning system 100 comprises a voltage-controlled oscillator (VCO) 6 controlled by an analog signal V_{T} and a first binary signal D. The analog signal V_{T} is inputted to a window comparator 1, said comparator 1 having a low threshold V_{L} which is indicative for low frequency and a high threshold V_{H} which is indicative for the high frequency. Optionally the window comparator 1 is achieved in a device as shown in FIG. 2. The window comparator 1 comprises a first differential comparator 11 and a second differential comparator 12. The first differential comparator generates a first signal S1 having a first binary value whenever the analog signal V_{T} is bigger than the high threshold V_{H}. The second differential comparator generates a second signal S2 having a second binary value whenever the analog signal V_{T} is smaller that the low threshold V_{L}. In the embodiment shown in FIG. 4 the signals V_{H}, V_{L}, V_{T}, S1 and S2 are voltages. A window comparator 1having the respective signals as currents or a combination of voltages and currents thereof could be relatively easy imagined by a skilled person in the art. In the embodiment of the window comparator 1 shown in FIG. 2 the signals S1 and S2 have a HIGH value when indicating that V_{T} is bigger than V_{H} or smaller than V_{L}. Otherwise the binary signals have a LOW value. Corresponding to a relationship between the voltages and the binary signals, the following table could be generated.

TABLE

| STATE | S1 | S2 |
|---|---|---|
| V_{T} < V_{L} | LOW | HIGH |
| V_{L} < V_{T} < V_{H} | LOW | LOW |
| V_{T} > V_{H} | HIGH | LOW |

It is observed that the for a person skilled in the art it would be relatively easy to derive obvious alternatives to the schematic shown in FIG. 2 and to the Table, having in mind that the window comparator 1 should generate three different combinations for the signals S1, S2.

The signals generated by the window comparator 1 are inputted to a controller 3, the controller 3 generating the first binary signal D for digitally control an output frequency of the voltage-controlled oscillator 6. The controller further generates a second binary signal DIV that is inputted to a frequency divider 4 for determining a division factor of a periodical signal S generated by the voltage-controlled oscillator 6. The controller 3 includes a local memory for storing a binary representation of the frequency range and of each of the bands included in the frequency range. The tuning system 100 further comprises a PLL loop. The PLL loop includes a phase detector 5 coupled to the frequency divider 4. The phase detector 5 generates an error signal that is proportional to a phase difference between a phase of a reference periodical signal f_{REF} and a phase of a signal generated by the frequency divider 4. The error signal is inputted to a compound bloc 7 comprising a charge pump coupled to a loop filter, the compound bloc 7 generating the analog signal V_{T}.

Tuning systems are normally tuned before delivering to a customer and, therefore, a tuning method for a tuning system according to the invention is desirable. Therefore, in the following considerations, a method for tuning a tuning system 100 according to the invention is presented.

It is considered that the first binary signal is D=d1d2 . . . dn where di is 0 or 1 and the any switch SW1, SW2, . . . , SWn is turned ON when the respective di is 1. It results for the circuit shown in FIG. 3 that the overall capacity could be written as

$$C = {\sum }_{i = 1}^{n} diCi .$$

Any capacitor Ci, i=1 . . . n, could be implemented as passive capacitors or as MOS capacitors. The preceding relation emphasizes the direct relation between the overall capacity and the first binary signal D. The first signal S1 is used as an indication whether the analog signal V_{T} is bigger than V_{H}. In this situation it results that the frequency generated by the VCO 6 is bigger than a maximum possible frequency and therefore two actions are considered. Firstly, the second binary signal DIV is modified such that the frequency of the signal generated by the divider is lowered. Secondly, the first digital signal D is for lowering the frequency of the signal S generated by the VCO increasing the overall capacity of the circuit shown in FIG. 3. An analogous mechanism is provided in the situation when the analog signal V_{T} is lower that the signal V_{L} and the second signal S2 is HIGH. The first and the second binary signals D and respectively DIV are store in the local memory of the controller 3 being available for an automatic tuning or for a further calibration of the tuning system 100.

The tuning mechanism could be summarize as follows:

1. Setting all the switches SW1 . . . SWn in an OFF state i.e. D=00 . . . 0;

2. Modifying the second binary signal DIV sequentially until the first signal S1 is HIGH;

3. Setting all the switches SW1 . . . SWn in an ON state i.e. D=11 . . . 1;

4. Modifying the second binary signal DIV sequentially until the second signal S2 is HIGH;

5. Setting the first binary signal D=00 . . . 1;

6. Adjusting the second binary signal DIV till the first signal S1 becomes HIGH;

7. Adjusting the second binary signal DIV till the second signal S2 becomes HIGH;

8. Storing the second binary signal DIV codes in the controller 3 memory;

9. Modifying the first binary signal D to the next value i.e. D=0 . . . 10; and

10. Repeating steps 6 to 9 until all possible D values are used.

Let us make the following notations: Nmax is the division factor obtained in step 2, Nmin is the division factor obtained in step 4, NH is the division factor obtained in step 6, NL is the division factor obtained in step 7.

It is observed that the frequency of the signal generated by the frequency divider is the frequency of the signal S divided by the decimal equivalent number of the second binary signal DIV e.g. D_{N}. Let us note the frequency of the signal S as fS. It results that after division the frequency of the signal is fS/D_{N}. It is further observed that a useful number is Nrange=NH−NL that indicates how many division numbers are used for tuning within a given frequency band i.e. how many division numbers are necessary for the window comparator to be maintained in a state S1 S2=01. Therefore, using the stored numbers for every frequency band the locking process is quickened. The tuning mechanism above described is used for the calibration of the tuning system. A tuning system failing to correspond to this tuning mechanism has to be rejected because it means that there are frequency bands in the frequency range that could not be covered by the tuning system. Hence, the tuning mechanism improves the quality control of the tuning systems using an analog and a binary control for the VCO.

In the description of the invention the meaning of frequency range FR and frequency band FB are considered as in FIG. 4.

It is remarked that the scope of protection of the invention is not restricted to the embodiments described herein. Neither is the scope of protection of the invention restricted by the reference numerals in the claims. The word ‘comprising’ does not exclude other parts than those mentioned in the claims. The word ‘a(n)’ preceding an element does not exclude a plurality of those elements. Means forming part of the invention may both be implemented in the form of dedicated hardware or in the form of a programmed purpose processor. The invention resides in each new feature or combination of features.

1. A tuning system for receiving a radio frequency input signal included in a frequency range the range having a plurality of non-overlapping bands, a maximum frequency and a minimum frequency, the tuning system comprising a voltage-controlled oscillator controlled by an analog signal and a first binary signal and being characterized in that the analog signal is inputted to a window comparator, said comparator having a low threshold which is indicative for the minimum frequency and a high threshold which is indicative for the maximum frequency.

2. A tuning system as claimed in claim 1, wherein the window comparator generates a signal that is inputted to a controller, for generating the first binary signal to digitally control an output frequency of the voltage-controlled oscillator.

3. A tuning system as claimed in claim 2, wherein the controller further generates a second binary signal that is inputted to a frequency divider for determining a division factor of a periodical signal generated by the voltage-controlled oscillator.

4. A tuning system as claimed in claim 2, wherein the controller further comprises a local memory for storing a binary representation of the frequency range and of each of the bands included in the frequency range.

5. A tuning system as claimed in claim 3 further comprising a phase-locked loop, the phase-locked loop including a phase detector coupled to the frequency divider, the phase detector generating an error signal that is proportional to a phase difference between a phase of a reference periodical signal and a phase of a signal generated by the frequency divider, the error signal being inputted to a compound bloc comprising a charge pump coupled to a loop filter, the compound bloc generating the analog signal.

6. A tuning system as claim in claim 1, wherein the window comparator comprises a first differential comparator and a second differential comparator, the first differential comparator generating a first signal having a first binary value whenever the analog signal is bigger than the high threshold, the second differential comparator generating a second signal having a second binary value whenever the analog signal is smaller that the low threshold.

7. A tuning system as claimed in claim 1, wherein the voltage-controlled oscillator comprises a plurality of capacitors coupled respectively to a plurality of switches, a state of said switches being controlled by the first digital signal.

8. A tuning system as claimed in claim 3, wherein the window comparator comprises a first differential comparator and a second differential comparator, the first differential comparator generating a first signal having a first binary value whenever the analog signal is larger than the high threshold, the second differential comparator generating a second signal having a second binary value whenever the analog signal is smaller that the low threshold, wherein the voltage-controlled oscillator comprises a plurality of capacitors coupled respectively to a plurality of switches, a state of said switches being controlled by the first digital signal and the first digital signal comprises a plurality of binary signals each of the binary signals controlling a respective switch, a tuning method further comprising steps of:
1. Setting all the switches in an OFF state so that the first digital signal=00 . . . 0;
2. Modifying the second binary signal sequentially until the first signal is HIGH;
3. Setting all the switches in an ON state so that the first digital signal=11 . . . 1;
4. Modifying the second binary signal sequentially until the second signal is HIGH;
5. Setting the first binary signal=00 . . . 1;
6. Adjusting the second binary signal till the first signal becomes HIGH;
7. Adjusting the second binary signal till the second signal becomes HIGH;
8. Storing the second binary signal codes in memory of the controller;
9. Modifying the first binary signal to the next value; and
10. Repeating steps 6 to 9 until all possible values of the first digital signal are used.

9. Use of the tuning method claimed in claim 8 for quality control of the tuning systems having a VCO controlled by an analog signal and a binary signal in a manufacturing process and for quick locking on a frequency of an external signal in an exploitation process.
